(19) United States
(12) Patent Application Publication
(10) Pub. No.: US 2010/0154954 A1
(43) Pub. Date: Jun. 24, 2010

(54) PNEUMATIC TIRE AND METHOD FOR MANUFACTURING THE SAME

(75) Inventor: Keisuke SAOTOME, Hiratsuka-shi (JP)

Correspondence Address: HAMRE, SCHUMANN, MUELLER & LARSON, P.C., P.O. BOX 2902, MINNEAPOLIS, MN, 55402-0902, US

(73) Assignee: THE YOKOHAMA RUBBER CO., LTD., Tokyo (JP)

(21) Appl. No.: 12/613,337

(22) Filed: Nov. 5, 2009

(30) Foreign Application Priority Data
Dec. 18, 2008 (JP) 2008-322470

(51) Int. Cl. B60C 5/10

(52) U.S. Cl. 152/344.1

(57) ABSTRACT

A pneumatic tire includes: a plurality of rubber sheet layers being layered in a tire radial direction, the rubber sheet layers including an first layer and a second layer, wherein each of the first layer and the second layer includes a plurality of divided sheets being spliced at spliced positions dividing a circumferential length in a tire circumferential direction by lengths having integer values, a total of the lengths being substantially corresponding to a nominal diameter of the pneumatic tire, and wherein the spliced positions of the first layer and the spliced positions of the second layer are set to be shifted in the tire circumferential direction to be unoverlapped with one another.

### CROSS-REFERENCE TO THE RELATED APPLICATION(S)

The present disclosure relates to the subject matters contained in Japanese Patent Application No. 2008-322470 filed on Dec. 18, 2008, which are incorporated herein by reference in its entirety.

### FIELD

The present invention relates to a pneumatic tire and a method for manufacturing the pneumatic tire, which is used for vehicles such as cars, trucks, and buses.

### BACKGROUND

Conventionally, in manufacturing a pneumatic tire, a rubber sheet having a length equal to the tire circumferential length according to the tire radial inch size is formed by cutting rubber belt having a width corresponding to the tire circumferential length into a length according to the width size of the tire, the rubber sheet is wound around a shape-forming drum and the both ends of the rubber sheet along the tire circumferential direction are spliced thereon, and thus, tire component members such as an inner liner and a carcass are formed on the shape-forming drum. An example of such manufacturing method is disclosed in JP-A-8-150670.

Since the rubber belt has a large width corresponding to the tire circumferential length, however, it is inconvenient for transportation and storage, and in addition, when tires different in the tire radial inch size are to be manufactured, it is necessary to exchange rubber belt with another rubber belt with a different width, and this exchange work disadvantageously takes a long time.

As a known countermeasure, rubber belt with a small width is used by dividing a rubber sheet along the tire circumferential direction and splicing the divided sheets, and when a tire with a different tire radial inch size is to be manufactured, rubber belt corresponding to a part of the divided rubber sheets is commonly used, so as to reduce the exchange time by exchanging merely rubber belt not commonly used. An example of such technique is disclosed in JP-A-2006-150684.

When the rubber sheet divided along the tire circumferential direction is used as in the conventional technique, however, the number of splice portions of the rubber sheet is larger as it is further divided, and if splice portions of members layered in the tire radial direction, such as an inner liner and a carcass, overlap each other, the uniformity of the tire is disadvantageously degraded.

### SUMMARY

One of objects of the present invention is to provide a pneumatic tire and a method for manufacturing the same in which even when a rubber sheet divided along the tire circumferential direction is used, exchange time necessary for coping with another tire different in the tire radial inch size can be reduced and the uniformity of the tire can be improved.

According to an aspect of the invention, there is provided a pneumatic tire including: a plurality of rubber sheet layers being layered in a tire radial direction, the rubber sheet layers including an first layer and a second layer, wherein each of the first layer and the second layer includes a plurality of divided sheets being spliced at spliced positions dividing a circumferential length in a tire circumferential direction by lengths having integer values, a total of the lengths being substantially corresponding to a nominal diameter of the pneumatic tire, and wherein the spliced positions of the first layer and the spliced positions of the second layer are set to be shifted in the tire circumferential direction to be unoverlapped with one another.

According to another aspect of the invention, there is provided a method for manufacturing a pneumatic tire, the method including: layering a plurality of rubber sheet layers in a tire radial direction, the rubber sheet layers including an first layer and a second layer, wherein each of the first layer and the second layer is being formed by a plurality of divided sheets being spliced at spliced positions dividing a circumferential length in a tire circumferential direction by lengths having integer values, a total of the lengths being substantially corresponding to a nominal diameter of the pneumatic tire, and wherein the spliced positions of the first layer and the spliced positions of the second layer are set to be shifted in the tire circumferential direction to be unoverlapped with one another.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a partial front cross-sectional view of a pneumatic tire according to an embodiment of the invention.

FIG. 2 is a side view of splice positions of a carcass and an inner liner.

FIG. 3 is a plan view illustrating a step of forming a rubber sheet.

FIG. 4 is a plan view illustrating another step of forming the rubber sheet.

FIG. 5 is a plan view illustrating another step of forming the rubber sheet.

FIG. 6 is a plan view illustrating another step of forming the rubber sheet.

FIG. 7 is a plan view illustrating another step of forming the rubber sheet.

FIG. 8 is a plan view illustrating another step of forming the rubber sheet.

FIG. 9 is a plan view illustrating another step of forming the rubber sheet.

FIG. 10 is a plan view illustrating another step of forming the rubber sheet.

FIG. 11 is a plan view illustrating another step of forming the rubber sheet.

FIG. 12 is a plan view illustrating another step of forming the rubber sheet.

FIG. 13 is a perspective view illustrating a step of winding a rubber sheet around a shape-forming drum.

FIG. 14 is another perspective view illustrating the step of winding another rubber sheet around the shape-forming drum.

FIGS. 15A and 15B are schematic side views of the carcass and the inner liner.

FIGS. 16A and 16B are another schematic side views of the carcass and the inner liner.

FIG. 17 is a diagram illustrating an exemplary combination of dividing ratios.

FIG. 18 is a diagram illustrating another exemplary combination of dividing ratios.

FIG. 19 is a diagram illustrating results of a test.

FIG. 20 is a diagram illustrating results of another test.

### DETAILED DESCRIPTION OF THE EMBODIMENTS

Hereinafter, embodiments of the invention will be described with reference to the drawings. In the following description, the same or similar components will be denoted by the same reference numerals, and the duplicate description thereof will be omitted.

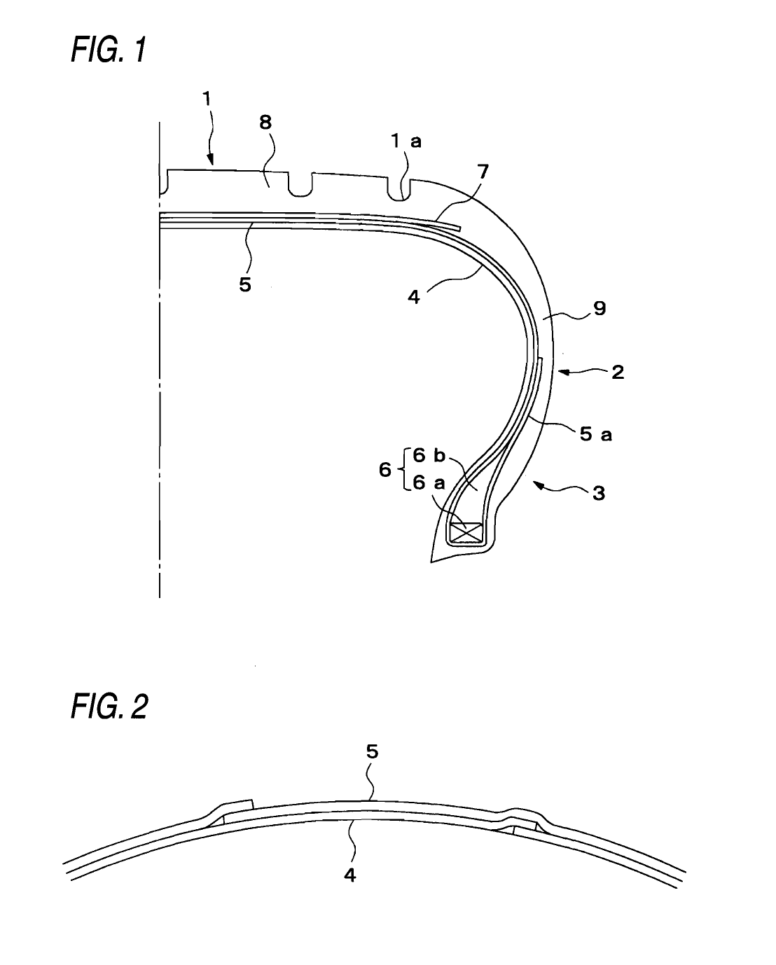

As shown in FIGS. 1 and 2, a pneumatic tire according to an embodiment includes a tread part 1 formed on the side of the outer circumference of the tire, a pair of sidewall parts 2 formed on the both sides along the width direction of the tire, and a pair of bead parts 3 formed on the both sides along the width direction of the tire. Also, the pneumatic tire includes an inner liner 4 disposed on the inner side of the tire, a carcass 5 disposed outside the inner liner 4, a pair of bead members 6 disposed on the both sides along the width direction of the tire, a belt 7 disposed outside the carcass 5, a tread member 8 disposed on the side of the outer circumference of the tire, and a pair of sidewall members 9 disposed on the both sides of the tire.

The inner liner 4 is made of a rubber sheet with low gas permeability mainly including butyl rubber and is disposed on the side of the inner circumference of the carcass 5.

The carcass 5 is made of a rubber sheet in which a plurality of carcass cords 5a are arranged along the tire circumferential direction, and the both ends thereof along the width direction are folded toward the sidewall 2 from the inside to the outside along the tire width direction so as to enfold the bead member.

The bead member 6 includes a bead core 6a including a bundle of wires such as metal wires and a bead filler 6b made of rubber with a substantially triangle cross-section, and the bead filler 6b is disposed outside the bead core 6a.

The belt 7 is configured by coating a belt cord made of a steel, high strength fiber or the like with a rubber sheet, and is disposed on the side of the outer circumference of the carcass 5.

The tread member 8 is made of rubber formed by extrusion molding, is disposed so as to cover a center portion along the width direction of the carcass 5 and the outer circumference of the belt 7, and has, on its outer circumference, grooves 1a as a tread pattern formed during vulcanizing molding.

The sidewall member 9 is made of rubber formed by the extrusion molding and is disposed so as to cover the both sides along the tire width direction of the carcass 5.

Next, a method for manufacturing a pneumatic tire of this embodiment will be described. Incidentally, steps described below are merely a part of a manufacturing process for the pneumatic tire and the other steps are omitted because those other steps may be performed as in a conventional technique.

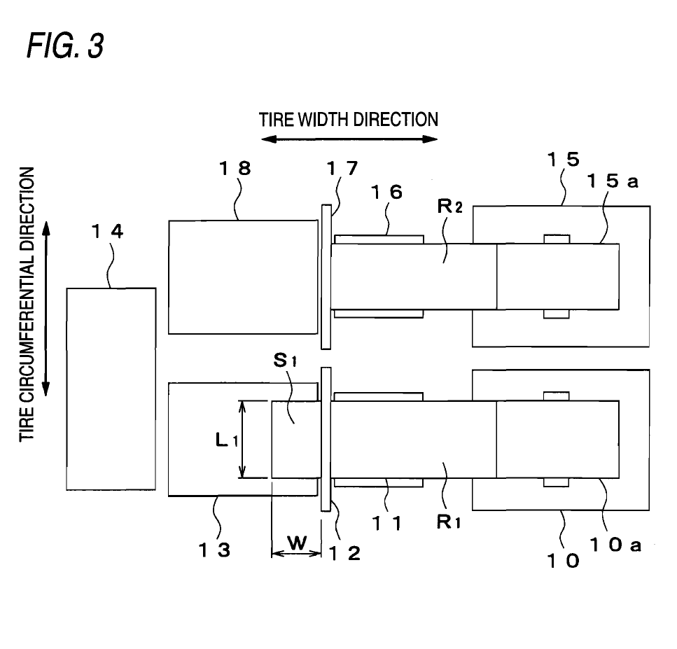

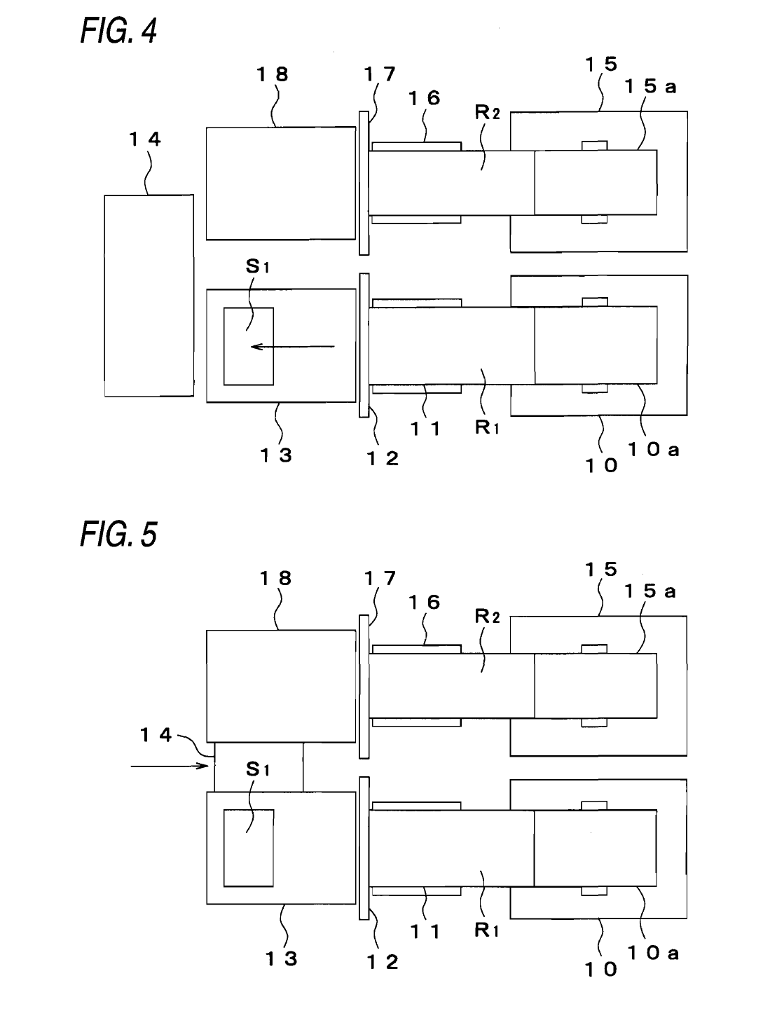

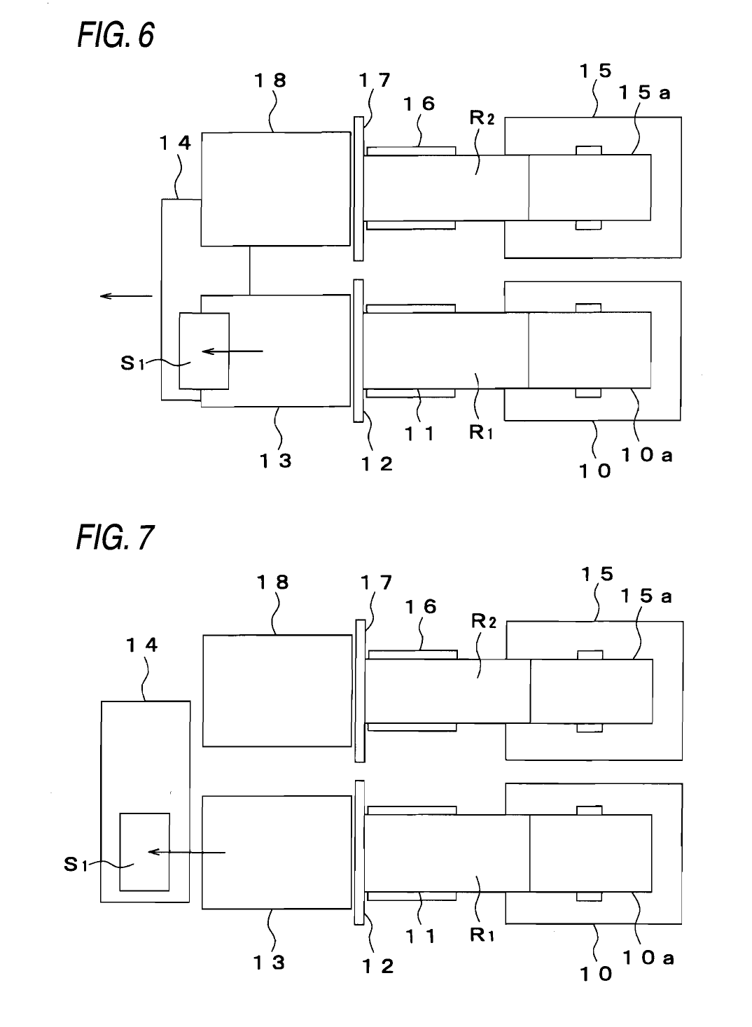

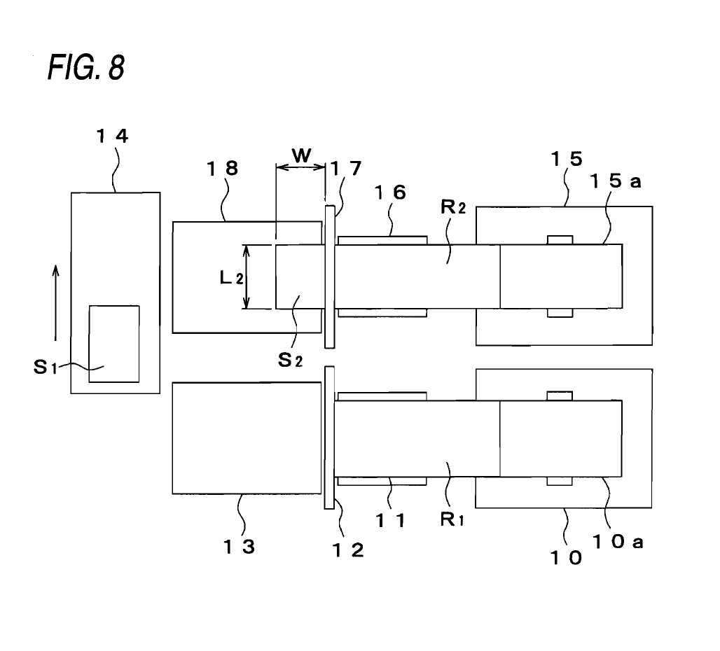

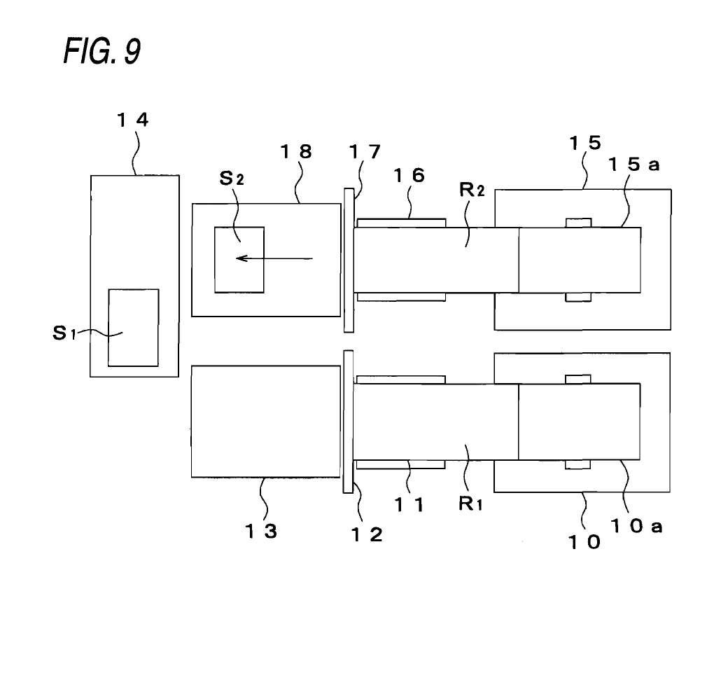

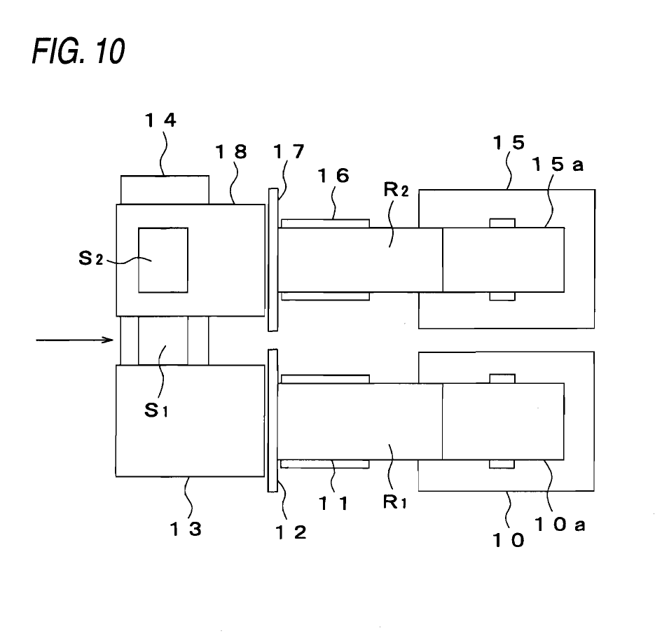

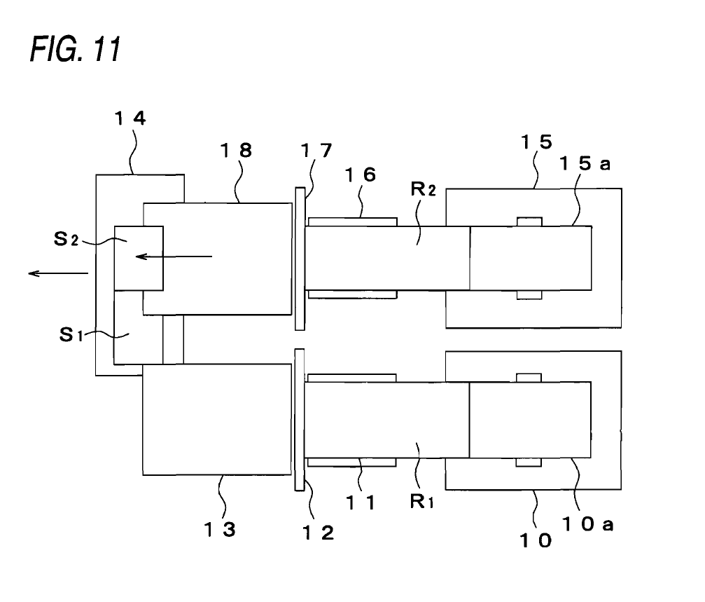

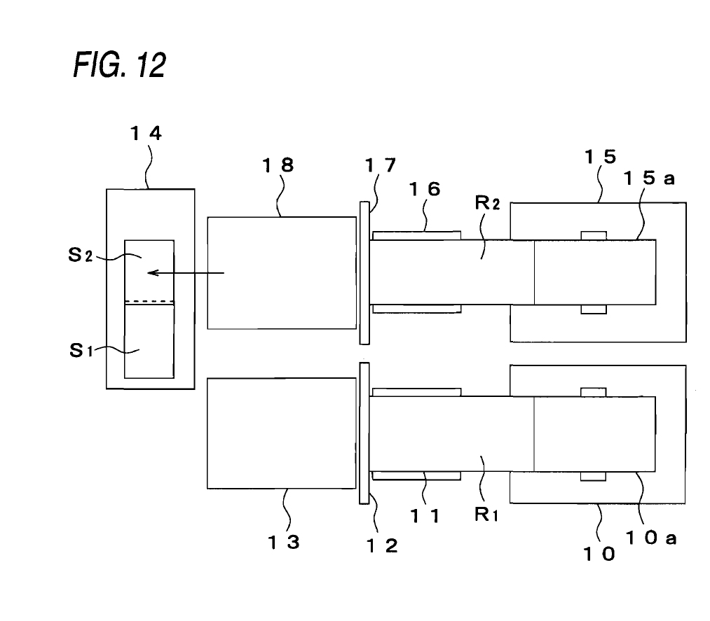

First, in a step of forming a rubber sheet to be used as an inner liner 4 or a carcass 5, as illustrated in FIG. 3, first rubber belt R1 drawn out from a drum 10a of a first carriage 10 is carried by a first conveyor 11 in a lengthwise direction (toward a first side along a tire width direction) and is cut with a cutter 12 along a width direction (corresponding to a tire circumferential direction) into a prescribed width W, thereby forming a first divided sheet S1. Next, as illustrated in FIG. 4, the first divided sheet S1 is moved onto a second conveyor 13, and as illustrated in FIG. 5, a tray 14 is moved toward a second side along the tire width direction to be placed below the second conveyor 13. Subsequently, as illustrated in FIG. 6, the tray 14 is moved toward the first side along the tire width direction while feeding the first divided sheet S1 by the second conveyor 13 in the same direction, thereby moving the first divided sheet S1 onto the tray 14 as illustrated in FIG. 7. Thereafter, as illustrated in FIG. 8, second rubber belt R2 drawn out from a drum 15a of a second carriage 15 is carried by a third conveyor 16 in the lengthwise direction (toward the first side along the tire width direction) and is cut with a cutter 17 along the width direction (corresponding to the tire circumferential direction) into a prescribed width W, thereby forming a second divided sheet S2. Next, after moving the tray 14 toward a first side along the tire circumferential direction, the second divided sheet S2 is moved onto a fourth conveyor 18 as illustrated in FIG. 9, and the tray 14 is moved toward the second side along the tire width direction to be placed below the fourth conveyor 18 as illustrated in FIG. 10. Subsequently, as illustrated in FIG. 11, the tray 14 is moved toward the first side along the tire width direction while feeding the second divided sheet S2 by the fourth conveyor 18 in the same direction, thereby moving the second divided sheet S2 onto the tray 14 so as to have a first side end along the tire circumferential direction of the second divided sheet S2 to overlap a second side end along the tire circumferential direction of the first divided sheet S1. Then, the divided sheets S1 and S2 are spliced to each other, so as to form the rubber sheet to be used as the inner liner 4 or the carcass 5.

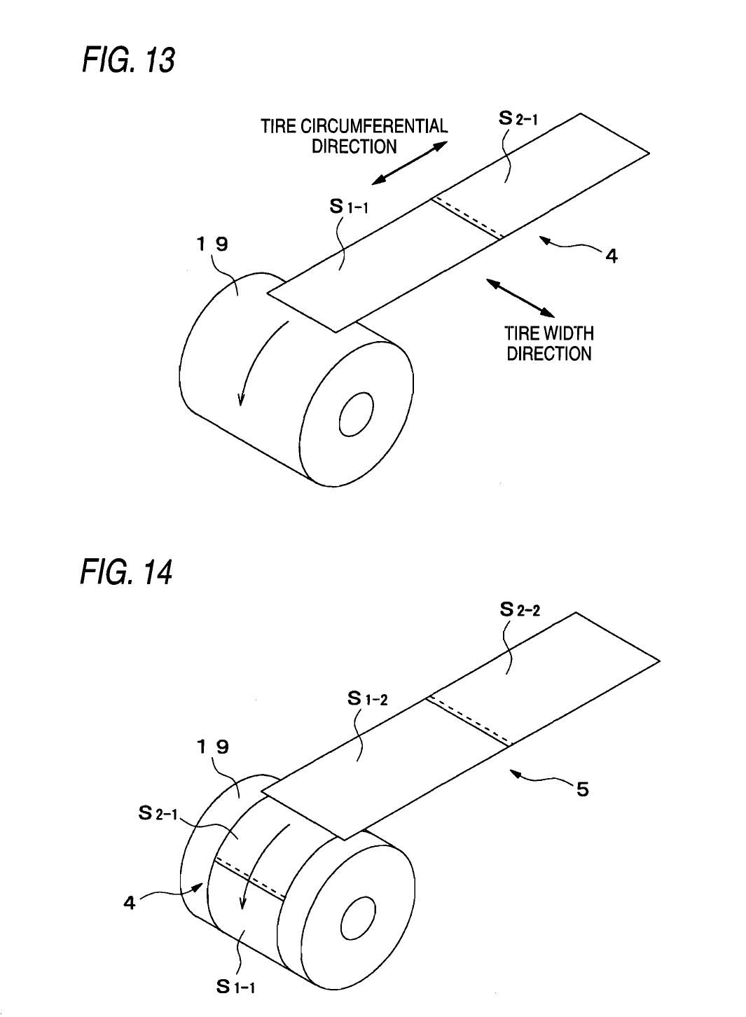

Next, after forming the sheet-shaped inner liner 4 (composed of divided sheets S1-1 and S2-1) and the sheet-shaped carcass 5 (composed of divided sheets S1-2 and S2-2) in the aforementioned manner, the inner liner 4 is wound around a shape-forming drum 19 so as to splice its ends along the tire circumferential direction to each other as illustrated in FIG. 13, and the carcass 5 is wound around the shape-forming drum 19 over the inner liner 4 so as to splice its ends along the tire circumferential direction to each other as illustrated in FIG. 14. Thus, the inner liner 4 and the carcass 5 are layered as illustrated in FIG. 2.

In this case, each of the inner liner 4 and the carcass 5 is divided along the tire circumferential direction in accordance with a plurality of integer values N1, N2, etc. whose sum corresponds to the nominal diameter (inch size) of a tire to be manufactured, and the inner liner 4 and the carcass 5 are arranged to have their splice positions shifted from each other.

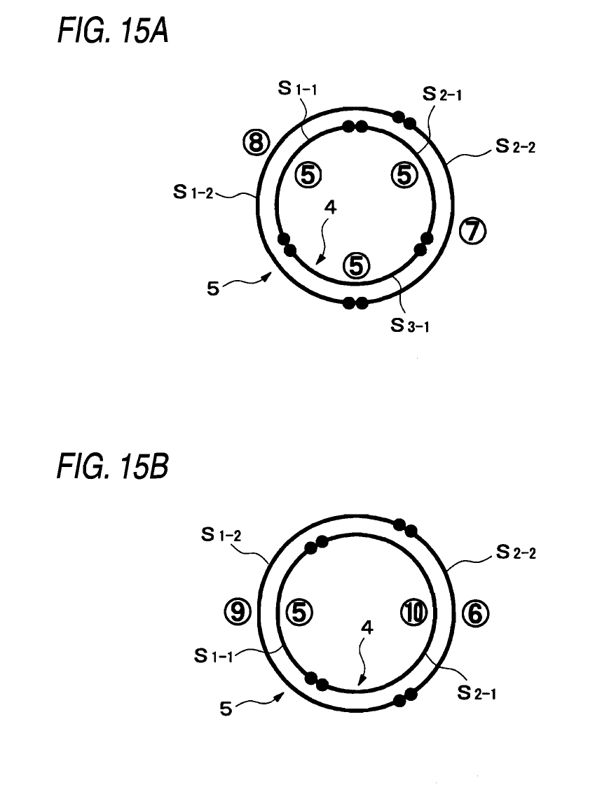

Specifically, the inner liner 4 and the carcass 5 are formed to be different from each other in the dividing ratio along the tire circumferential direction as illustrated in FIGS. 15A and 15B. In the case where the nominal diameter of the tire is, for example, 15 inches, integer values N1, N2 and N3 of first, second and third divided sheets S1-1, S2-1 and S3-1 of the inner liner 4 are all set to “5”, integer values N1 and N2 of first and second divided sheets S1-2 and S2-2 of the carcass 5 are set respectively to “8” and “7”, and splice positions between the divided sheets S1-1, S2-1 and S3-1 of the inner liner 4 and the splice positions between the divided sheets S1-2 and S2-2 of the carcass 5 are arranged to be shifted from each other along the tire circumferential direction as illustrated in FIG. 15A. Alternatively, integer values N1 and N2 of first and second divided sheets S1-1 and S2-1 of the inner liner 4 are set respectively to “5” and “10”, integer values N1 and N2 of first and second divided sheets S1-2 and S2-2 of the carcass 5 are set respectively to “9” and “6”, and splice positions between the divided sheets S1-1 and S2-1 of the inner liner 4 and the splice positions between the divided sheets S1-2 and S2-2 of the carcass 5 are arranged to be shifted from each other along the tire circumferential direction as illustrated in FIG. 15B.

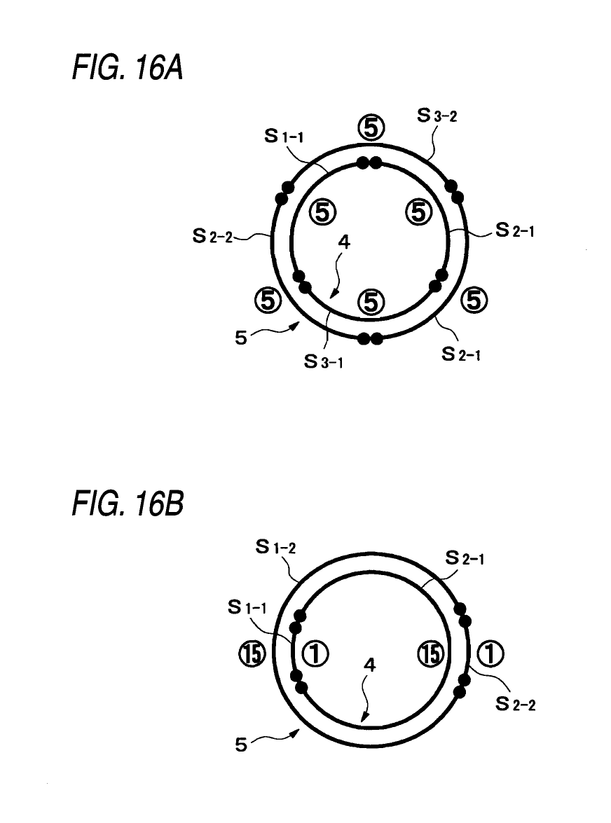

Alternatively, the inner liner 4 and the carcass 5 may be formed to have the same dividing ratio along the tire circumferential direction and may be arranged so as to have their splice positions point symmetrically to each other about the center along the tire radial direction as illustrated in FIGS. 16A and 16B. In the case where the nominal diameter of the tire is, for example, 15 inches, integer values N1, N2 and N3 of first, second and third divided sheets S1-1, S2-1 and S3-1 of the inner liner 4 are all set to “5”, integer values N1, N2 and N3 of first, second and third divided sheets S1-2, S2-2 and S3-2 of the carcass 5 are also all set to “5”, and splice positions between the divided sheets S1-1, S2-1 and S3-1 of the inner liner 4 and splice positions between the divided sheets S1-2, S2-2 and S3-2 of the carcass 5 are arranged to be point symmetrical and shifted from each other along the tire circumferential direction as illustrated in FIG. 16A. Alternatively, in the case where the nominal diameter of the tire is 16 inches, integer values N1 and N2 of first and second divided sheets S1-1 and S2-1 of the inner liner 4 are set respectively to “15” and “1”, integer values N1 and N2 of first and second divided sheets S1-2 and S2-2 of the carcass 5 are set respectively to “1” and “15”, and splice positions between the divided sheets S1-1 and S2-1 of the inner liner 4 and the splice positions between the divided sheets S1-2 and S2-2 of the carcass 5 are arranged to be point symmetrical and shifted from each other along the tire circumferential direction as illustrated in FIG. 16B.

Alternatively, in the case where a plurality of kinds of tires different from one another in the nominal diameter are to be manufactured, a rubber sheet in which at least one of divided sheets has a length along the tire circumferential direction corresponding to a common integer value N1, N2 or the like is used.

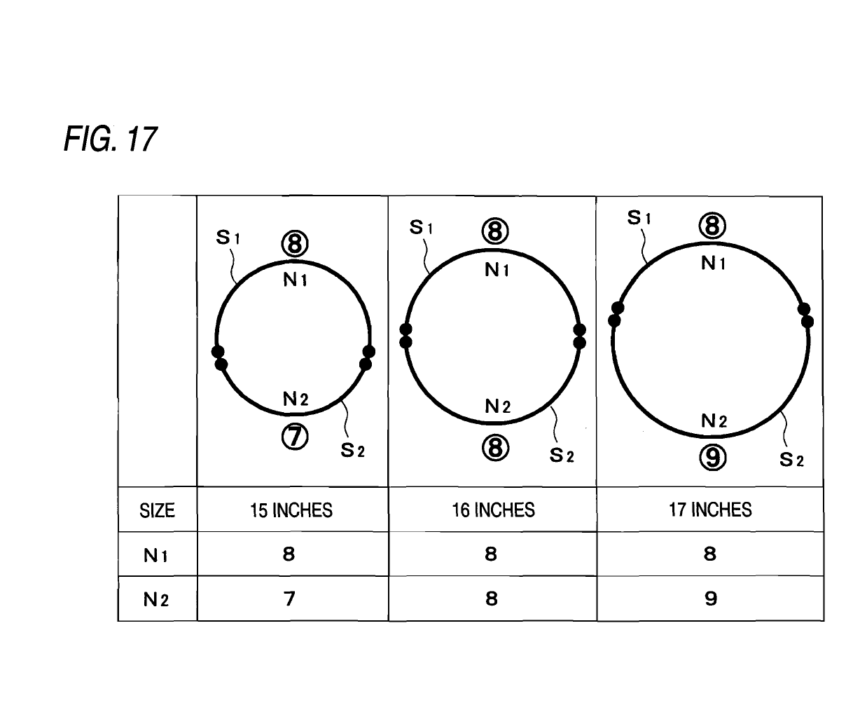

In the case where, for example, tires having nominal diameters of 15 inches, 16 inches and 17 inches are to be manufactured, when integer values N1 and N2 of first and second divided sheets S1 and S2 of a 15-inch tire are set respectively to “8” and “7”, integer values N1 and N2 of first and second divided sheets S1 and S2 of a 16-inch tire are both set to “8” and integer values N1 and N2 of first and second divided sheets S1 and S2 of a 17-inch tire are set respectively to “8” and “9” as illustrated in FIG. 17, the first divided sheet S1 (with the integer value N1 of “8”) can be commonly used for all the tires of these inch sizes.

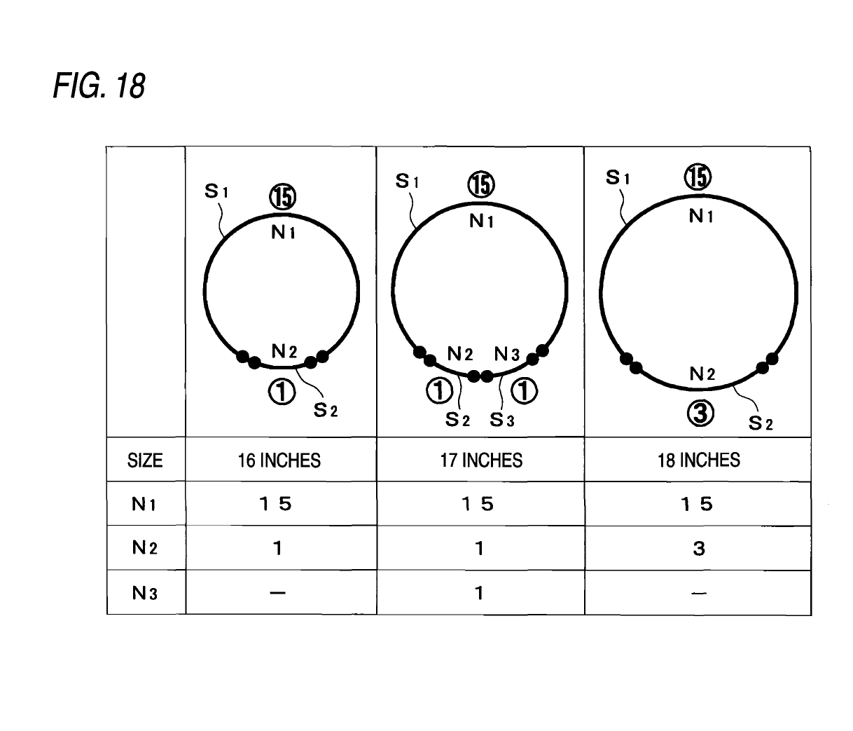

Alternatively, in the case where, for example, tires having nominal diameters of 16 inches, 17 inches and 18 inches are to be manufactured, when integer values N1 and N2 of first and second divided sheets S1 and S2 of a 16-inch tire are set respectively to “15” and “1”, integer values N1, N2 and N3 of first, second and third divided sheets S1, S2 and S3 of a 17-inch tire are set respectively to “15”, “1” and “1” and integer values N1 and N2 of first and second divided sheets S1 and S2 of an 18-inch tire are set respectively to “15” and “3” as illustrated in FIG. 18, the first divided sheet S1 (with the integer value N1 of “15”) can be commonly used for all the tires of these inch sizes.

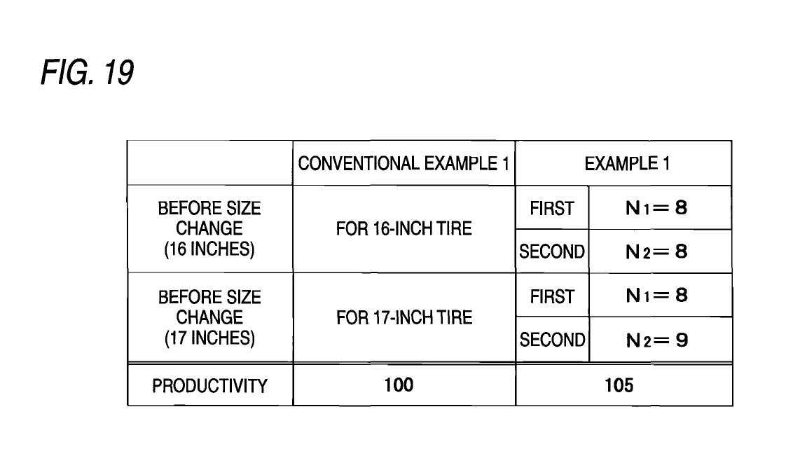

At this point, tires manufactured in Example 1 according to this invention and Conventional Example 1 were tested for the productivity of tires, resulting in obtaining results as illustrated in FIG. 19. In Conventional Example 1, a rubber sheet for a 16-inch tire not divided in the tire circumferential direction was used for manufacturing 16-inch unvulcanized tires, and thereafter, another rubber sheet for a 17-inch tire was used for manufacturing 17-inch unvulcanized tires. On the other hand, in Example 1, a rubber sheet divided into two divided sheets along the tire circumferential direction was used for manufacturing 16-inch unvulcanized tires with integer values N1 and N2 of the first and second divided sheets S1 and S2 set both to “8”, and thereafter, with integer values N1 and N2 of the first and second divided sheets S1 and S2 set respectively to “8” and “9”, 17-inch unvulcanized tires were manufactured.

In this test, the production per day was calculated on the basis of time taken to fabricate 100 tires with a tire size 215/50R17 after manufacturing 100 tires with a tire size 215/50R16, the calculated production was expressed with an index with the production of Conventional Example 1 regarded as an index of 100, and the productivity was evaluated to be superior as the value of the index was larger. As a result of the test, although it took 15 through 30 minutes to perform the exchange work for changing the tire size in Conventional Example 1, there was no need to perform the exchange work in Example 1 because the first divided sheet S1 (with the integer value N1 of “8”) was commonly used for the tires of the respective inch sizes, and hence, Example 1 is superior to Conventional Example 1 in the productivity.

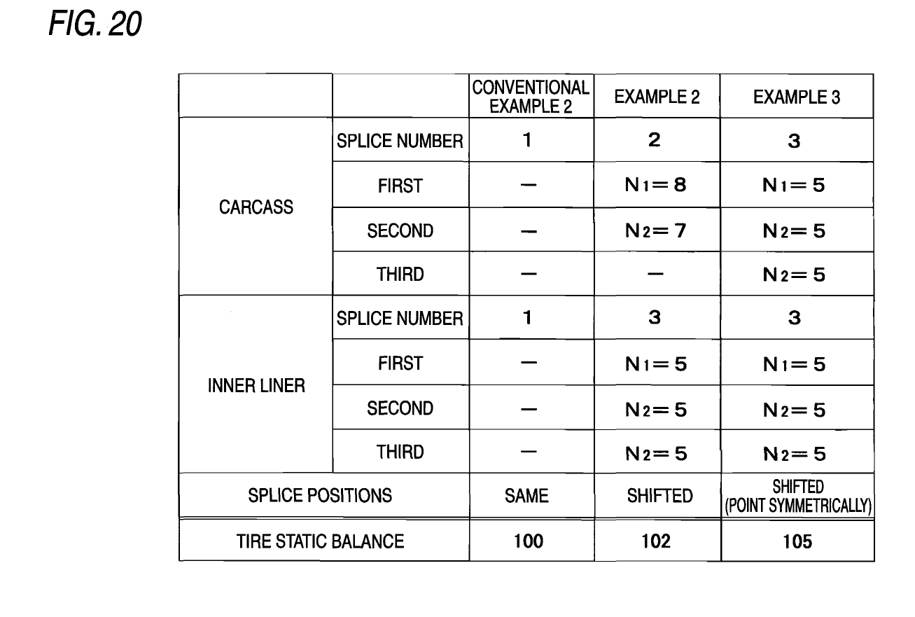

Next, tires manufactured in Examples 2 and 3 of this invention and Conventional Example 2 were tested for the tire static balance, resulting in obtaining results illustrated in FIG. 20. In Conventional Example 2, each of a carcass and an inner liner was spliced in one position along the tire circumferential direction, and the carcass and the inner liner were layered to have their splice positions overlapping in the tire circumferential direction. In Example 2, a carcass and an inner liner respectively divided in the tire circumferential direction in different dividing ratios were layered to have the splice positions shifted in the tire circumferential direction. Specifically, the carcass of Example 2 was made of a rubber sheet in which integer values N1 and N2 of first and second divided sheets S1 and S2 were set respectively to “8” and “7”, and the inner liner was made of a rubber sheet in which integer values N1, N2 and N3 of first, second and third divided sheets S1, S2 and S3 were all set to “5”. Also, in Example 3, a carcass and an inner liner respectively divided in the tire circumferential direction in the same dividing ratio were disposed to have the splice positions arranged point symmetrically about the center along the tire radial direction. Specifically, each of the carcass and the inner liner of Example 3 was made of a rubber sheet in which integer values N1, N2 and N3 of first, second and third divided sheets S1, S2 and S3 were all set to “5”. It is noted that tires with a tire size 205/60R15 were used in this test.

In this test, the tire static balance was measured in accordance with JASOC607, and the measured tire static balance was expressed with an index with that of Conventional Example 2 regarded as an index of 100, so as to evaluate the tire static balance to be superior as the value of the index was larger. As a result of the test, tires of Examples 2 and 3 are superior to those of Conventional Example 2 in the tire static balance and are improved in the uniformity.

As described so far, according to this embodiment, the rubber sheet to be used as the carcass 5 or the inner liner 4 is spliced in positions obtained by dividing the tire circumference in accordance with a plurality of integer values N1, N2, etc. whose sum corresponds to the nominal diameter of the tire. Therefore, when a rubber sheet in which at least one of divided sheets has a length along the tire circumferential direction corresponding to an integer value common to various tire sizes is used, the at least one divided sheet can be commonly used for the various tire sizes, and therefore, time taken to perform the exchange work for coping with tires with a different radial inch size can be reduced. Furthermore, since the carcass 5 and the inner liner 4 are disposed to have their splice positions shifted in the tire circumferential direction, the tire static balance can be improved, so as to improve the uniformity.

In this case, since the carcass 5 and the inner liner 4 respectively divided in the tire circumferential direction in different dividing ratios are layered in the tire radial direction, the splice positions can be easily shifted in the tire circumferential direction, which is very advantageous for improving the uniformity.

Alternatively, since the carcass 5 and the inner liner 4 respectively divided in the tire circumferential direction in the same dividing ratio are layered to have the splice positions point symmetrically about the center along the tire radial direction, the splice positions can be shifted in the tire circumferential direction at equal intervals, resulting in further improving the uniformity.

Moreover, the carcass 5 and the inner liner 4, each of which has been obtained by splicing divided sheets, are respectively wound around the shape-forming drum 19 and spliced at their ends in the tire circumferential direction. Therefore, they can be easily wound around the shape-forming drum 19, resulting in improving the productivity.

Incidentally, although the carcass 5 and the inner liner 4 are formed in this embodiment, the present invention is applicable to any rubber sheet used as any of other tire component members.

It is to be understood that the invention is not limited to the specific embodiments described above and that the invention can be embodied with the components modified without departing from the spirit and scope of the invention. The invention can be embodied in various forms according to appropriate combinations of the components disclosed in the embodiments described above. For example, some components may be deleted from the configurations described as the embodiments. Further, the components described in different embodiments may be used appropriately in combination.

What is claimed is:

1. A pneumatic tire comprising:
a plurality of rubber sheet layers being layered in a tire radial direction, the rubber sheet layers comprising an first layer and a second layer,
wherein each of the first layer and the second layer comprises a plurality of divided sheets being spliced at spliced positions dividing a circumferential length in a tire circumferential direction by lengths having integer values, a total of the lengths being substantially corresponding to a nominal diameter of the pneumatic tire, and
wherein the spliced positions of the first layer and the spliced positions of the second layer are set to be shifted in the tire circumferential direction to be unoverlapped with one another.

2. The pneumatic tire according to claim 1,
wherein the spliced positions of the first layer are set to have a first split ratio in the tire circumferential direction, and
wherein the spliced positions of the second layer are set to have a second split ratio in the tire circumferential direction, the second split ratio being different from the first split ratio.

3. The pneumatic tire according to claim 1,
wherein the spliced positions of the first layer are set to have a first split ratio in the tire circumferential direction,
wherein the spliced positions of the second layer are set to have a second split ratio in the tire circumferential direction, the second split ratio being different from the first split ratio, and
wherein the spliced positions of the first layer and the spliced positions of the second layer are arranged to be symmetrical about a center of the pneumatic tire.

4. The pneumatic tire according to claim 1,
wherein the first layer is an inner liner, and
wherein the second layer is a carcass.

5. A method for manufacturing a pneumatic tire, the method comprising:
layering a plurality of rubber sheet layers in a tire radial direction, the rubber sheet layers comprising an first layer and a second layer,
wherein each of the first layer and the second layer is being formed by a plurality of divided sheets being spliced at spliced positions dividing a circumferential length in a tire circumferential direction by lengths having integer values, a total of the lengths being substantially corresponding to a nominal diameter of the pneumatic tire, and
wherein the spliced positions of the first layer and the spliced positions of the second layer are set to be shifted in the tire circumferential direction to be unoverlapped with one another.

6. The method according to claim 5,
wherein the spliced positions of the first layer are set to have a first split ratio in the tire circumferential direction, and
wherein the spliced positions of the second layer are set to have a second split ratio in the tire circumferential direction, the second split ratio being different from the first split ratio.

7. The method according to claim 5,
wherein the spliced positions of the first layer are set to have a first split ratio in the tire circumferential direction,
wherein the spliced positions of the second layer are set to have a second split ratio in the tire circumferential direction, the second split ratio being different from the first split ratio, and
wherein the spliced positions of the first layer and the spliced positions of the second layer are arranged to be symmetrical about a center of the pneumatic tire.

8. The method according to claim 5,
wherein each of the first layer and the second layer is formed by a process comprising:
wounding a rubber sheet on a forming drum, the rubber sheet comprising the divided sheets being preliminarily spliced except at both ends; and
splicing the rubber sheet being wound on the forming drum to splice the both ends.

9. The method according to claim 5,
wherein a rubber sheet in which at least one of the divided sheets having a length along the tire circumferential direction corresponding to a common integer value is used for manufacturing a plurality of types of tires that are different in a nominal diameter.

10. The method according to claim 5,
wherein the first layer is an inner liner, and
wherein the second layer is a carcass.
